(19) United States
(12) Patent Application Publication
(10) Pub. No.: US 2007/0119390 A1
(43) Pub. Date: May 31, 2007

(54) SYSTEM AND METHOD FOR OPERATING AN INTERNAL COMBUSTION ENGINE

(76) Inventors: Mark L. Herrmann, Bonita Springs, FL (US); David Wesseldyk, Jenison, MI (US)

Correspondence Address: WOOD, HERRON & EVANS, LLP, 2700 CAREW TOWER, 441 VINE STREET, CINCINNATI, OH, 45202, US

(21) Appl. No.: 11/289,845

(22) Filed: Nov. 30, 2005

(51) Int. Cl. F02B 43/00; F02M 43/00; F02M 51/00

(52) U.S. Cl. 123/1 A; 123/304; 123/478

(57) ABSTRACT

A method of operating an internal combustion engine generally comprises supplying a primary fuel having a first octane rating at to an intake manifold of the engine, supplying an amount of racing fuel concentrate to the intake manifold in response to a signal associated with engine load, and varying the amount of the racing fuel concentrate supplied to the intake manifold in response to variance of the signal. The racing fuel concentrate is a petroleum distillate racing fuel, such as Torco® Mach Series Accelerator Race Fuel Concentrate, that significantly increases the octane rating of the primary fuel when the concentrate is supplied to the manifold.

### FIELD OF THE INVENTION

The present invention relates generally to internal combustion engines, and more particularly to method of operating an internal combustion engine in response to engine loads.

### BACKGROUND

In a reciprocating internal combustion engine, a mixture of air and fuel is generally combusted within a cylinder in order to convert chemical energy into thermal energy. The high-pressure gases resulting from this combustion expand against a piston that is adapted to reciprocate within the cylinder and drive a rotating crankshaft. Thus, the chemical energy of the fuel is ultimately converted into mechanical energy that may be used to power an automobile or any other mechanism

One of the challenges associated with such an engine is appropriately timing the start of combustion during the engine cycle. This is particularly true for spark-ignited (SI) engines, which control the start of combustion by appropriately timing a spark plug that ignites an air-fuel mixture within the cylinder. The spark plug is often timed such that the start of combustion occurs when the piston is positioned near the top, or head, of the cylinder during the end of its reciprocal movement.

However, during the compression stroke of the piston, the increased pressure within the cylinder raises the temperature of the air-fuel mixture. If the temperature is raised high enough, the mixture will uncontrollably detonate or self-ignite without the use of a spark plug. The result is a phenomenon known as engine “knock” or “ping,” which generates pulses of extremely high pressure throughout the engine. In some cases the piston will still be moving towards the cylinder head when self-ignition occurs. As such, the piston cannot simply reverse its motion to ease the build-up of pressure in the cylinder and the engine may become permanently damaged.

In order to limit the temperature and pressure of the air-fuel mixture at the end of the compression stroke, the static compression ratio of an SI engine is typically kept within a particular range of values. For example, the ability of a fuel to resist self-ignition is generally determined by its anti-knock index (AKI), which is commonly referred to as the octane number (ON) or octane rating of the fuel. Most gasoline fuels for automobiles have octane numbers ranging from 87 to 93. In order to avoid self-ignition with these “pump fuels,” the static compression ratios of SI engines are typically kept between approximately 8:1 and approximately 11:1.

Some SI engines may experience knock despite these relatively low static compression ratios. For example, many high performance and racing engines are equipped with a supercharger or turbocharger to increase the net power output of the engine. These forced induction systems compress the air supplied to the cylinder so that a greater amount of the air-fuel mixture can be combusted during each engine cycle. Thus, supercharges and turbochargers provide the engine with an “effective” compression ratio, which is basically the sum of the static compression ratio plus the additional compression resulting from the forced induction.

The effective increase in compression ratio raises the temperature and pressure within the cylinder to levels unsuitable for regular pump fuels (87 to 93 ON). A higher octane fuel must therefore be readily available to prevent engine knock during peak operating conditions. More specifically, the octane number of the fuel supplied to the engine at peak operating conditions must be sufficient to resist self-ignition at the pressures and temperatures associated with the peak conditions.

One approach to addressing this problem is to inject alcohol into the manifold of the engine when the effective compression ratio increases. Alcohol fuels, such as methanol and ethanol, are generally capable of withstanding higher compression ratios because of their relatively high heats of vaporization (h_{fg}). In other words, alcohol fuels generally have higher rates of evaporative cooling than conventional pump fuels and thus are more effective at cooling the charge and cylinder walls within the combustion chamber. Water injection has also been used in internal combustion engines for substantially the same reasons.

While injecting alcohol may suffice for some applications, there are many drawbacks associated with such fuels. In particular, alcohol fuels only offer a limited increase in compression ratio. Both methanol and ethanol have octane numbers of approximately 100, which is generally not sufficient to prevent self-ignition under the pressures and temperatures experienced by racing engines. Additionally, alcohol fuels only have about half of the energy content as conventional gasoline fuels. This means that almost twice as much alcohol must be burned to give the same energy input to the engine as gasoline. Unless the storage tank for the alcohol injection system is relatively large, the duration over which an engine will be able to operate at high compression ratios without refilling the tank may be limited. Furthermore, alcohol fuels may be more corrosive than gasoline on fuel lines, storage tanks, gaskets, and other metal engine parts. These and other disadvantages are the primary reasons why alcohol fuels have not been used as the main source vehicle fuel in most countries.

Another approach to preventing knock in a forced induction system is to convert regular octane fuel into high octane fuel by adding a racing fuel concentrate. Racing fuel concentrates are petroleum distillates (UN no. 1268) that can be mixed with pump fuel to produce a significant increase in octane number. For example, Torco® Racing Fuels produces an unleaded concentrate as part of its “Mach-1” fuel series that, when blended with a 93 octane super unleaded fuel, makes up to a 104 octane race fuel. Torco® also produces a leaded concentrate as part of its Mach-1 series that can be mixed with 100-octane low-lead aviation fuel to get up to 112 octane race fuel. The concentrates are typically blended with pump fuel within the engine's fuel tank or within a separate container and subsequently supplied to an empty fuel tank. Thus, whenever a racing fuel concentrate is used, the engine's fuel tank is filled with a high octane fuel so that the engine does not experience knock.

At relatively low loads, however, the effective compression ratio of the engine is substantially the same as the static compression ratio and a higher octane fuel is not needed. For example, in a supercharged engine the supercharger is driven by the engine's crankshaft. At low RPM's, the air supplied to the cylinder will not be significantly compressed and a regular octane fuel (87 to 93 ON) will be sufficient to operate the engine without experiencing knock. Any high octane fuel supplied to the engine during these low loads will not generate additional power or improve fuel economy. Therefore, the racing fuel concentrate used to make the high octane fuel is essentially wasted until the engine begins to experience the pressures and temperatures associated with higher loads (i.e., higher effective compression ratios). This waste is particularly undesirable due to the high costs associated with the racing fuel concentrate.

### SUMMARY OF THE INVENTION

The present invention provides a method of operating an internal combustion engine in a manner that involves supplying amounts of racing fuel concentrate to the intake manifold of the engine on an as-needed basis. Such a method helps eliminate the wasted costs associated with the current methods of using racing fuel concentrate, as will be apparent from the description below.

More specifically, the method comprises supplying a primary fuel having a first octane rating to the intake manifold. For example, the primary fuel may be a gasoline “pump” fuel with an octane rating of 87. In order to bring the primary fuel to a second octane rating that is greater than the first octane rating, an amount of racing fuel concentrate is supplied to the intake manifold in response to a signal associated with the engine load. The racing fuel concentrate is a low-solubility, petroleum distillate that has been processed as premium racing fuel. For example, the racing fuel concentrate may be Torco® Mach Series Accelerator Race Fuel Concentrate.

The method further comprises varying the amount of the racing fuel concentrate supplied to the intake manifold in response to variance of the signal. In this manner, the engine may be designed to run on the primary fuel at relatively low engine loads without experiencing knock. When temperatures and pressures within the engine increase to levels unsuitable for the primary fuel, the racing fuel concentrate may be added to prevent self-ignition within the combustion chamber.

The effective compression ratio is increased as the supercharger boost or turbocharger boost is increased. Therefore, hypothetically if it is safe to use a ratio of racing fuel concentrate to gasoline at a volume ratio of 1:80 at 8 PSI boost but unsafe to run a higher boost with the same concentration of concentrate, the concentration must be increased to a hypothetical ratio of 4:80 when the boost pressure reaches 21 PSI, assuming of course that the concentrate can raise the octane level to the desired level. Therefore, in order to achieve that ratio, the amount of concentrate per 80 volume units of gasoline needs to be increased hypothetically from 1 to 4 volume units, for example. The present system varies concentration of the racing fuel additive per unit volume of gasoline, depending on the boost level and resultant effective compression ratio.

Various systems for implementing such a method are also provided herein. In several of the systems, the signal associated with the engine load is the air pressure of the engine manifold. These systems are particularly suited for engines having a forced induction system, such as a turbocharger or supercharger, that increases the effective compression ratio of the engine as the load increases.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a schematic view of a system for operating an internal combustion engine;

FIG. 2 is a schematic view of an alternative system that incorporates an electronic control unit for operating an internal combustion engine;

FIG. 3 is a schematic view of a further system for operating an internal combustion engine, the system incorporating a flow valve;

FIG. 4A is a cross-sectional view of showing the flow valve of FIG. 3 in a closed position; and

FIG. 4B is a cross-sectional view showing the flow valve of FIG. 3 in an open position.

### DETAILED DESCRIPTION

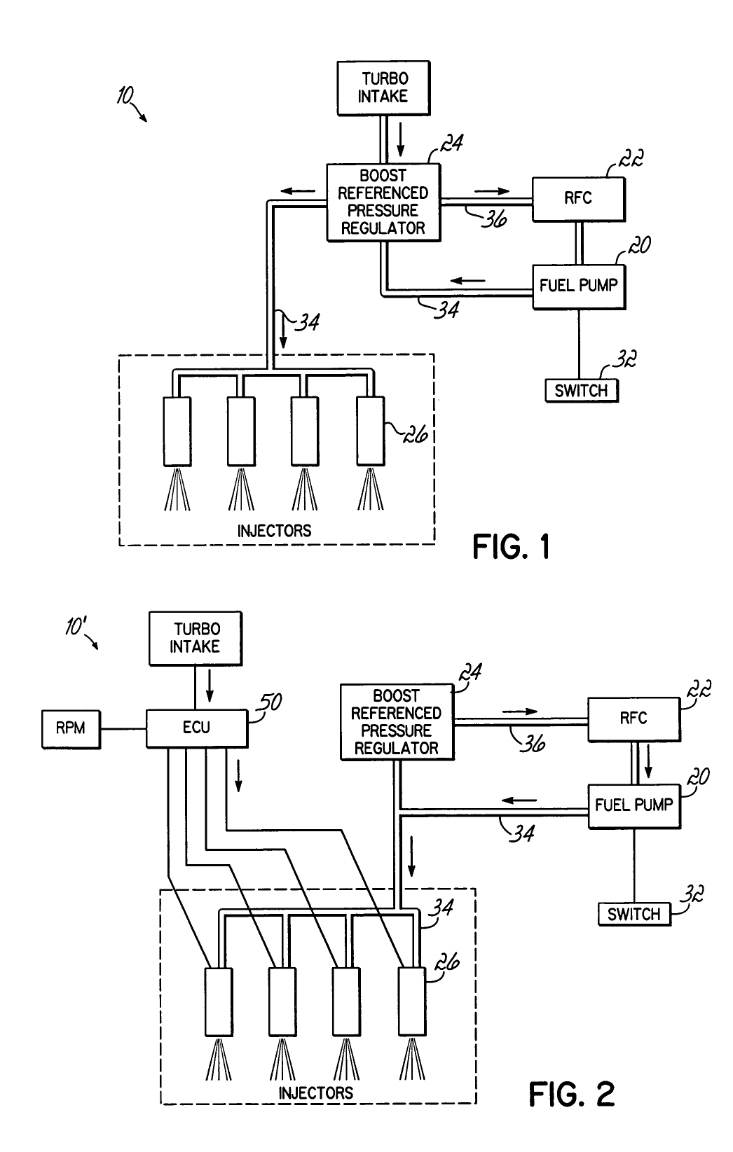

FIGS. 1-3 illustrate various systems for operating an internal combustion engine. Each of the systems may be used to implement one or more methods according to the invention. More specifically, each of the systems enables racing fuel concentrate to be supplied to the engine on an as-needed basis. Although only three systems are shown and described herein, those skilled in the art will appreciate from the following description that other systems and arrangements may be used to implement methods according to the invention.

As a preliminary matter, the term “racing fuel concentrate” refers to a petroleum distillate (UN no. 1268) for premium racing fuels. In other words, the term refers to a product made from crude oil that has been distilled in a refinery and processed in a manner consistent with the production of racing fuels. One example of such a product is Torco® Mach Series Accelerator Race Fuel Concentrate. Racing fuel concentrates typically have a solubility in water of less than approximately 25 percent by volume, and in some cases, may even have a solubility of approximately nil. Racing fuel concentrates also have a specific gravity at 60 degrees Fahrenheit of less than approximately 0.79, and more preferably, a specific gravity between approximately 0.74 and approximately 0.76.

The most important property of racing fuel concentrates, however, relates to their ability to increase the octane rating (anti-knock index) of pump fuels when mixed therewith. Only a small amount of racing fuel concentrate is needed to significantly raise the octane number of gasoline. For example, when 80 parts of 93-octane gasoline is mixed with one part of Torco® Mach-1 Unleaded Race Fuel Concentrate, the octane number of the gas increases to 97. When 80 parts of 93-octane gasoline is mixed with two parts of Torco® Mach-1 Unleaded Race Fuel Concentrate, the octane number of the gas increases to 104. And finally, when 80 parts of 93-octane gasoline is mixed with four parts of Torco® Mach-1 Unleaded Race Fuel Concentrate, the octane number of the gas increases to 107. In order to produce such increases, the octane rating of the racing fuel concentrate itself must be greater than 120.

As mentioned above, FIG. 1 shows one example of a system 10 for supplying racing fuel concentrate to an engine on an as-needed basis. The system 10 includes a fuel pump 20, a supply or tank 22 of racing fuel concentrate, a pressure regulator 24, and one or more fuel injectors 26. The fuel pump 20 is activated by a switch 32 once the engine experiences a certain load. For example, in an engine with a forced induction system, the switch 32 may be designed to activate the fuel pump 20 when the air pressure in the manifold of the engine reaches a predetermined “set point.” The activated pump then delivers racing fuel concentrate from the supply 22 to the fuel injectors 26 via fuel lines 34. The pressure regulator 24 and a return fuel line 36 regulate the pressure of the racing fuel concentrate delivered to the fuel injectors 26, which ultimately discharge the concentrate into the intake manifold of the engine.

The system 10 shown in FIG. 1 is designed to supplement the engine's normal fuel supply system (not shown). In other words, a primary fuel having a first octane rating, such as 93-octane gasoline, is supplied to the intake manifold of the engine by separate fuel injectors (not shown). The engine may in fact be designed to run entirely upon the primary fuel under low and normal load conditions. For example, consider a supercharged, or “boosted,” engine having an 8:1 static compression ratio. Such an engine is generally capable of operating solely on the 93-octane gasoline until approximately 8 lbs. of “boost,” or positive air pressure, are added to the manifold. The amount of boost in a supercharged engine is associated with the engine load because the output of the engine drives the supercharger.

By the time the supercharger adds approximately 8 lbs. of boost, the effective compression ratio of the engine is approximately 12.4:1. At higher loads the engine will begin experiencing pressures and temperatures that would ordinarily cause the 93-octane fuel to self-ignite. The system 10 prevents this problem by supplying the racing fuel concentrate to the intake manifold to appropriately increase the octane rating of the 93-octane fuel. Thus, for the purposes of this example, the “set point” for the switch 32 is approximately 8 lbs. of boost. As loads continue to increase beyond the set point, the pressure regulator will be referenced to adjust the flow of racing fuel concentrate to the fuel injectors 26. Such an arrangement allows the amount of racing fuel concentrate supplied to the intake manifold to be instantaneously adjusted in response to variance of the engine load.

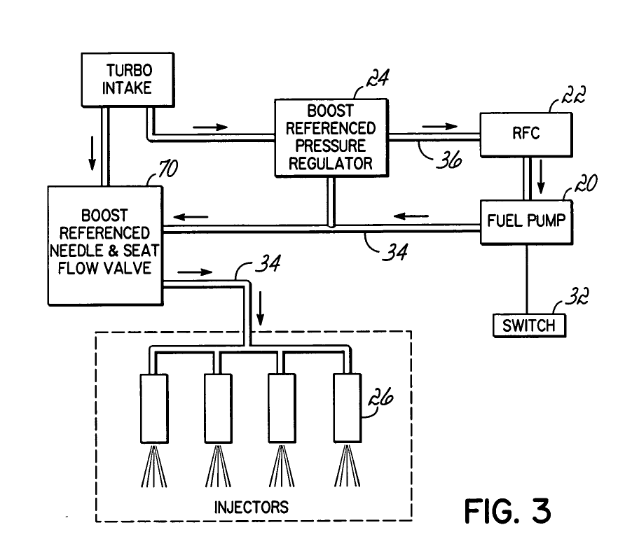

In the example shown in FIG. 2, the system 10′ further includes an electronic control unit (ECU) 50 to monitor engine load conditions. For example, the electronic control unit 50 may be used to monitor the manifold air pressure (i.e., boost), revolutions-per-minute (RPM), or other signals associated with engine load. This information is processed by the electronic control unit 50 to generate injection command pulses that are communicated to the fuel injectors 26. Thus, the electronic control unit 50 may be used to adjust the injection time of the fuel injectors 26, and thus the amount of racing fuel concentrate supplied to the manifold, in response to signals associated with the engine load.

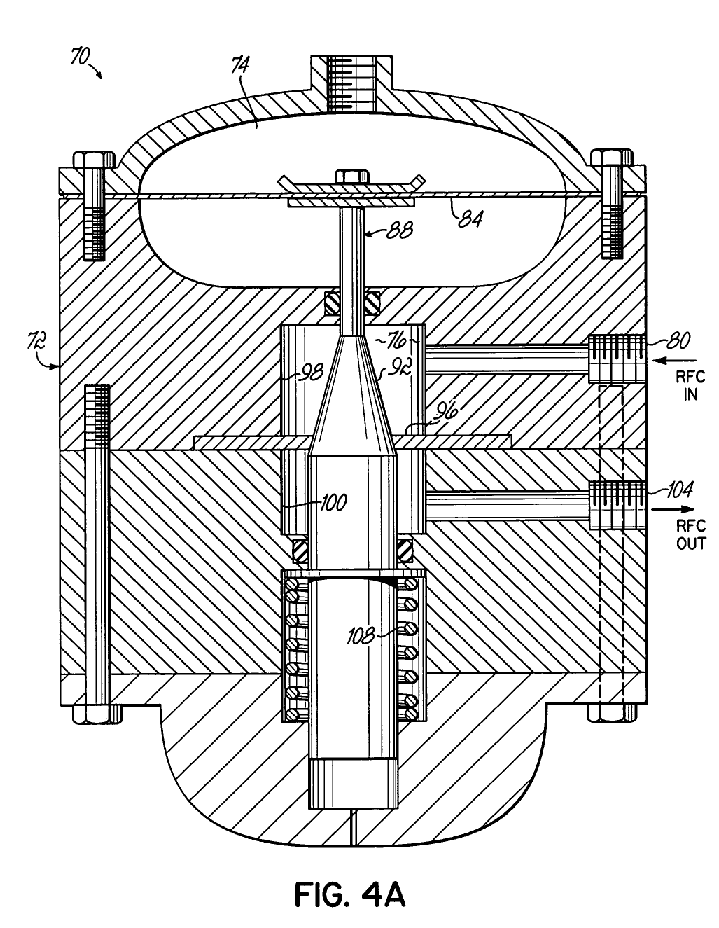

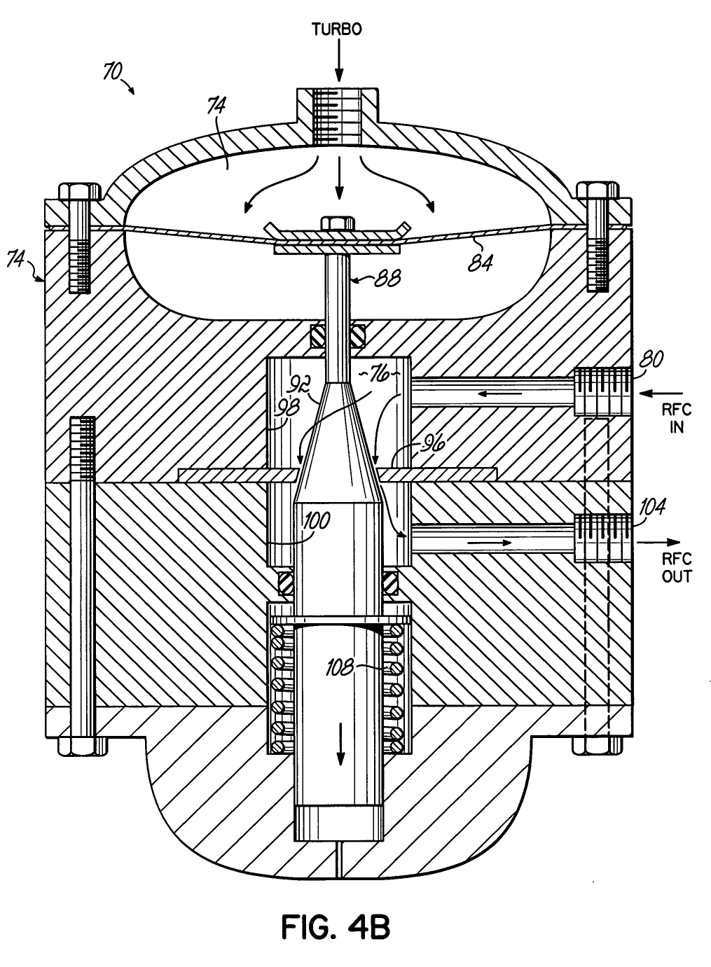

In the example shown in FIG. 3, the system 10′ further includes a flow valve 70 to control the amount of fuel delivered by the fuel injectors 26. As shown in FIGS. 4A and 4B, the flow valve 70 comprises a housing 72 that has a first chamber 74 communicating with the manifold air pressure (FIG. 4B) and a second chamber 76 adapted to receive the racing fuel concentrate through an intake passage 80. A diaphragm 84 positioned in the first chamber 74 is operatively connected to a needle 88 extending through the second chamber 76. The needle 88 has a tapered portion 92 that contacts a seat 96 within the second chamber 76 such that the second chamber 76 is divided into first and second portions 98, 100. This arrangement prevents racing fuel concentrate from flowing through the second chamber 76 and into an outtake passage 104.

The diaphragm 84 is adapted to move in response to the manifold air pressure of the engine. However, a spring 108 associated with the needle 88 is adapted to resist such movement. Thus, when the manifold air pressure exceeds the resistance of the spring 108, the diaphragm 84 and needle 88 will move downwardly to create an opening between the seat 96 and tapered portion 92 (FIG. 4B). Racing fuel concentrate can then flow from the intake passage 80, through the second chamber 76, and into the outtake passage 104, where it is ultimately delivered to the fuel injectors 26 (FIG. 3). If the manifold air pressure continues to increase, the tapered portion 92 will move further away from the seat 96 so that a greater amount of racing fuel concentrate may be delivered to the fuel injectors 26.

In each of the examples discussed above, racing fuel concentrate is delivered to the intake manifold of an engine only when it is necessary to increase the octane rating of the primary fuel and prevent engine knock. In order to further ensure that the engine will not be damaged by knock, the systems shown in FIGS. 1-3 may incorporate various safety features. For example, after the fuel pump 20 has been activated, a pressure switch (not shown) may be used to monitor the pressure of the racing fuel concentrate delivered to the fuel injectors 26. The pressure switch is adapted to be activated when the system reaches a minimum pressure set point. If this event does not occur within a predetermined time delay after the pump has been activated, a rev-limiter (not shown) will automatically limit the RPM's of the engine. Thus, the pressure switch ensures that sufficient racing fuel concentrate is discharged into the manifold before the engine begins to experience conditions that would otherwise lead to knock.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. For example, the invention may apply to naturally aspired engines in addition to engines having forced induction systems. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. A method of operating an internal combustion engine, comprising:
supplying a primary fuel having a first octane rating at to an intake manifold of the engine;
supplying an amount of racing fuel concentrate to the intake manifold in response to a signal associated with engine load to bring the primary fuel to a second octane rating, the second octane rating being greater than the first octane rating; and
varying the amount of the racing fuel concentrate supplied to the intake manifold in response to variance of the signal.

2. (canceled)

3. The method of claim 1, wherein the racing fuel concentrate has a solubility in water of less than approximately 25 percent by volume.

4. The method of claim 3, wherein the racing fuel concentrate has a solubility in water of approximately nil.

5. The method of claim 1, wherein the racing fuel concentrate has a specific gravity at 60 degrees Fahrenheit of less than approximately 0.79.

6. The method of claim 5, wherein the racing fuel concentrate has a specific gravity between approximately 0.74 and approximately 0.76.

7. The method of claim 1, wherein supplying the racing fuel concentrate to the intake manifold comprises:
activating a fuel pump to deliver the racing fuel concentrate from a fuel tank to a fuel injector; and
discharging the racing fuel concentrate into the intake manifold with the fuel injector.

8. The method of claim 7, wherein varying the amount of racing fuel concentrate supplied to the intake manifold comprises:
monitoring the signal associated with engine load with an electronic control unit; and
adjusting the injection time of the fuel injector with the electronic control unit in response to the signal associated with engine load.

9. The method of claim 7, wherein the signal associated with the engine load is the air pressure in the intake manifold.

10. The method of claim 7, wherein the signal associated with the engine load is the revolutions-per-minute (RPM) of the engine.

11. The method of claim 7, wherein supplying the racing fuel concentrate to the intake manifold further comprises:
controlling the pressure of the racing fuel concentrate delivered from the fuel tank to the fuel injector with a pressure regulator, the pressure regulator communicating with the air pressure in the intake manifold such that the pressure of the racing fuel concentrate delivered to the fuel injector corresponds to engine load.

12. The method of claim 7, wherein varying the amount of racing fuel concentrate supplied to the intake manifold comprises:
delivering the racing fuel concentrate from the fuel tank to a flow valve, the flow valve communicating with air pressure in the intake manifold; and
actuating the flow valve in response to the air pressure in the intake manifold to vary the amount of racing gas concentrate delivered to the fuel injector.

13. The method of claim 7, wherein the fuel pump is activated when the signal associated with the engine load reaches a predetermined value.

14. The method of claim 13, further comprising:
monitoring the pressure of the racing fuel concentrate delivered to the fuel injector with a pressure switch, the pressure switch adapted to be activated when a minimum pressure set point is reached; and
activating a rev-limiter to limit the revolutions-per-minute (RPM) of the engine if the pressure switch is not activated within a predetermined time delay after the fuel pump is activated.

15. A method of operating an internal combustion engine, comprising:
supplying eighty units of pump fuel at to an intake manifold of the engine;
supplying one to four units of racing fuel concentrate to the intake manifold in response to a signal associated with engine load to increase the octane rating of the pump fuel by at least two octane numbers; and
varying the amount of the racing fuel concentrate supplied to the intake manifold in response to variance of the signal.

16. The method of claim 15, wherein the signal associated with the engine load is the air pressure in the intake manifold.

17. A racing fuel concentrate delivery system for an internal combustion engine, the engine having a primary fuel supply system that delivers a primary fuel into an intake manifold, the delivery system comprising:
a supply of racing fuel concentrate;
a fuel injector adapted to discharge the racing fuel concentrate into the intake manifold of the engine;
a fuel pump adapted to deliver the racing fuel concentrate from said supply to said fuel injector; and
a pressure regulator adapted to vary the amount of racing fuel concentrate delivered to said fuel injector in response to a signal associated with the engine load.

18. A method of operating a turbocharged or supercharged engine to prevent engine knock and attendant damage to the engine comprising:
supplying gasoline having an octane rating that is insufficient to permit the engine to operate at a desired high boost level, and
increasing the boost level to the engine while simultaneously adding to the engine a quantity of racing fuel concentrate with the ratio of concentrate quantity to gasoline quantity being increased as needed as the boost increases.

19. The method of claim 15, wherein supplying one to four units of racing fuel concentrate further comprises increasing the octane rating of the pump fuel by at least eleven octane numbers.

20. A method of operating an internal combustion engine, comprising:
supplying an amount of primary fuel having a first octane rating at to an intake manifold of the engine;
supplying an amount of racing fuel concentrate to the intake manifold in response to a signal associated with an increase in engine load to bring the primary fuel to a second octane rating, the second octane rating being greater than the first octane rating; and
maintaining at least the same amount of primary fuel supplied to the intake manifold when the racing fuel concentrate is supplied to the intake manifold.

21. A method of operating a turbocharged or supercharged engine to prevent engine knock and attendant damage to the engine, comprising:
supplying a pump fuel to the engine at a first rate, the pump fuel having an octane rating that is insufficient to permit the engine to operate at a desired high boost level;
increasing the boost level of the engine to the desired high boost level;
supplying the pump fuel to the engine at a second rate higher than the first rate while the engine is operating at the desired high boost level; and
increasing the octane rating of the pump fuel by at least four octane numbers in response to increasing the boost level to the desired high boost level.
